(19) United States
(12) Patent Application Publication
(10) Pub. No.: US 2014/0318919 A1
(43) Pub. Date: Oct. 30, 2014

(54) COUPLING FIXTURE

(71) Applicant: Karl Hiestand, Pfullendorf (DE)

(72) Inventor: Karl Hiestand, Pfullendorf (DE)

(21) Appl. No.: 14/260,779

(22) Filed: Apr. 24, 2014

(30) Foreign Application Priority Data
Apr. 24, 2013 (EP) 13165134.1

(51) Int. Cl. F16D 13/38; F16D 27/14

(52) U.S. Cl. CPC F16D 13/38; F16D 27/14
USPC 192/66.32; 192/66.3

(57) ABSTRACT

A coupling fixture for reciprocal connection between two components rotating in opposite directions to one another, with a drive element and an axially adjustable coupling element in a rotationally fixed connection with the drive element or one of the two components. The two components are locked together directly, or by the coupling element, and the locking is released by moving the coupling element axially. Thereby rendering it possible to establish connection without the need for special controls and/or synchronisation of the components to be connected. Switching operations can be performed when the drive element and the coupling element are being driven with different speeds of rotation. It is thus possible to achieve a reliable and trouble-free operating method of the coupling fixture over a long period of time.

The present invention relates to a fixture for reciprocal connection between two components rotating in opposite directions to one another arranged on a drive element by means of an axially adjustable coupling element, in particular for connecting a drive element of an electrical clamping device with the same, by means of which the rotational adjustment movements of the drive element can be converted into axial adjustment movements.

As disclosed in EP 2384839 B 1, in an electrical clamping device for machine tools, in order to convert the adjustment movements of the rotor shaft of a servomotor into the axial adjustment movements of a draw rod required for actuating the clamping jaws of a power-operated chuck, there is provision for the servomotor to be connected by means of a controllably adjustable sliding sleeve via intermediate links and gearing to a movement converter in the clamping position of the clamping device. In the operating position, however, the servomotor can be decoupled by means of the sliding sleeve.

Although this embodiment has proven effective, in practice it has been revealed that coupling the sliding sleeve to the drive element connected to the drive motor cannot be accomplished without complications. The sliding sleeve that is continuously connected to the movement converter, and thus rotates with it in the operating position, can namely only be coupled to the drive element when the latter is driven with the same or almost the same speed as the sliding sleeve, or if the components to be connected are stationary. As a result, coupling requires an extraordinary degree of work in order to synchronise the components to be connected and, when they are moving synchronously, to be able to engage the sliding sleeve in the gearing of the drive element. In spite of the significant control complexity, it is nevertheless unavoidable for there to be differences in speed between the drive element connected to the servomotor, and the gearing on the sliding sleeve often collides with the gearing on the drive element as a result of which engagement is either impossible, or only possible to a limited extent. This leads to jams, and blockages or disruptions in operation entailing an interruption in the working procedure are thus often unavoidable.

The task of the present invention is therefore to create a fixture for reciprocal connection of two components with a drive element which has an extremely straightforward design, but nevertheless makes it possible to connect a component to the drive element without requiring special synchronisation, at any time and even when gearing is involved. Special control of the speed of rotation of the drive element should thus not be required, instead it should be guaranteed that the gearing components to be connected always engage completely with one another, as a result of which precise force transmission is guaranteed, and there is no need to accept disruptions in operation and consequential interruptions of work. Also, it should be possible to release the coupling element from the two components and allow it to rotate independently from them, together with the drive element.

In accordance with the present invention, this is achieved in a fixture of the aforementioned type in that the coupling element is in a rotationally fixed connection with the drive element or one of the two components, that the two components can be locked together directly or by means of the coupling element and that the locking of the two components can be released by means of moving the coupling element axially.

In accordance with a first embodiment of the fixture, the coupling element can be formed by an axially movable ring arranged in the drive element which is preferably configured as a disc, or by a plurality of pins which can be operated jointly and are inserted in the drive element, in which case the disc or pins can be connected to one of the two components in a rotationally fixed arrangement.

The coupling element inserted in the drive element can be actuated by means of a transmission element in this case, which can preferably be formed by one or more pins in an axially movable arrangement.

Furthermore, it is advantageous for the two components to be locked together in the neutral position of the coupling element by means of one or more detent pins that are inserted in one of the components and can be moved axially against the force of springs, and engage with openings provided in the other component, and that the coupling element or one of the components should be provided with a projection arranged approximately at the height of the detent pins, by means of which the detent pins can be actuated directly or by means of intermediate elements through the axial movement of the coupling element, thus releasing the lock.

According to a different embodiment, the coupling element can be provided with gearing or friction surfaces on one or both side surfaces which interact with corresponding gearing or friction surfaces provided on the drive element and/or on the component which is supported in a rotating arrangement.

In this configuration variant, in order to for the drive element to be connected to the coupling element under load, the distance between the surfaces of the gearing provided on the drive element and on the component in a rotating arrangement should be larger than the axial width of the coupling element. Also, the coupling element and the drive element should be able to be driven with the same or different speeds during engagement and disengagement procedures.

Furthermore, one or both of the gearings on the surfaces of the component in a rotating arrangement and on the coupling element can be equipped with a wear-resistant friction covering, a coating or knurling.

It is also appropriate for the interacting gearing provided on the coupling element and the drive element to be configured as trapezoidal gearing in order to allow high torques to be transmitted, and for the gearing provided on the coupling element and the component in a rotating arrangement to be configured as micro-gearing.

As a further embodiment, there is provision for the coupling element to be configured as a sliding sleeve and connected in a rotationally fixed arrangement with the component in a rotating arrangement by means of one or more stud bolts, with the coupling element connected to the latter component in a movable axial arrangement or connected to the drive element in a rotationally fixed arrangement.

With regard to the gearings provided for reciprocal connection of the coupling element with the component in a rotating arrangement and the drive element, the interacting gearings of the coupling element and the drive element should have a greater tooth depth than the reciprocal gearings provided on the component in a rotating arrangement and on the coupling element.

Moreover, it is appropriate for a servo device to be provided for axial adjustment of the coupling element, this device taking the form of an adjustable piston inserted in a cylinder which can be acted on by pressurised fluid on one or both sides and acts on the coupling element, or else an electrically operated servo device.

When there is a force-locking connection between the drive element and the coupling element, the adjustable element of the servo device acting on the coupling element should be provided with an insert supported in a rotating mounting in this element.

In accordance with a further embodiment, it is advantageous for a locationally fixed electromagnet to be used for axial adjustment of the coupling element, by means of which the coupling element can be adjusted in a controlled manner against the force of return springs.

Furthermore, it is highly advantageous for one or more springs to be inserted in the coupling element, which are effective in the direction of the component connected to the coupling element in a rotationally fixed arrangement, in which case each of the springs shall be arranged on a pressure piece firmly connected to one of the components or the component in a rotating arrangement, and on the free end of which the springs act.

In order for the axial position of the coupling element to be established, it is possible for one or more signal transmitters to be provided which preferably operate using a proximity-type method and can be influenced by the coupling element by means of switching cams or the like either directly or via intermediate elements, with the signals from these transmitters being sent to a control device or to the drive element and/or a drive motor allocated to the latter.

If a fixture is configured in accordance with the present invention for reciprocal connection of two components rotating in opposite directions to one another arranged on a drive element by means of a coupling element, it is possible for the connection in question to be established at any time without the need for particularly complicated control systems and/or synchronisation of the components that are to be connected. As a result of the particular specific configuration and connection of the individual components between one another, it is namely possible to carry out engagement and disengagement procedures even if the drive element and the coupling elements are driven at different speeds, without thereby incurring any jamming or blockage of the fixture. In this case, the connection of the coupling element can be relied on to take place only when the connection of the coupling element with the corresponding allocated component has been released. Also, in accordance with a variant embodiment, the coupling element can be separated from both components and rotate continuously with the drive element. There is thus no need for the drive element to be switched on and off during operation of the clamping device.

The structural complexity as well as the investments required in order to achieve this are exceedingly low, nevertheless a reliable and trouble-free operating method is provided over a long period without interruption. The application area for a clamping device equipped with a coupling fixture in accordance with the present invention is thus considerably extended, and it is also possible to transmit high drive forces from the drive element to the coupling element, and from this to the component to be driven, as well as establishing connections irrespective of the speeds at which the components are rotating.

The drawing shows some sample embodiments of the coupling fixture configured in accordance with the present invention, the details of which are explained below. In the drawing,

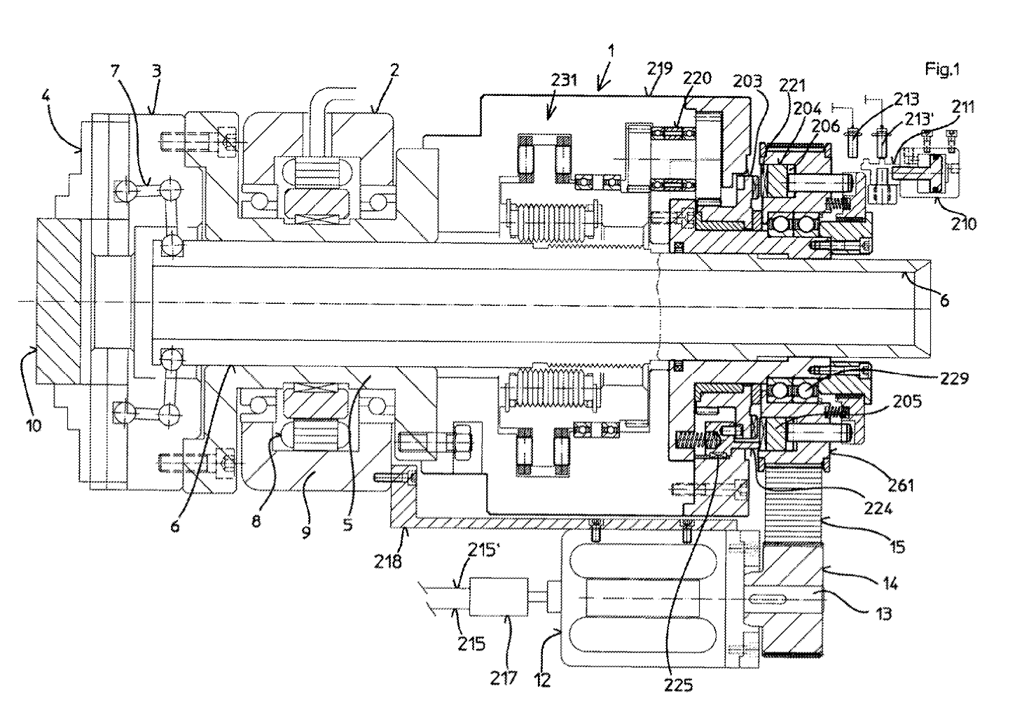

FIG. 1 shows a clamping device for a machine tool with coupling fixture inserted between the drive element and the clamping device, in a partial lengthways section,

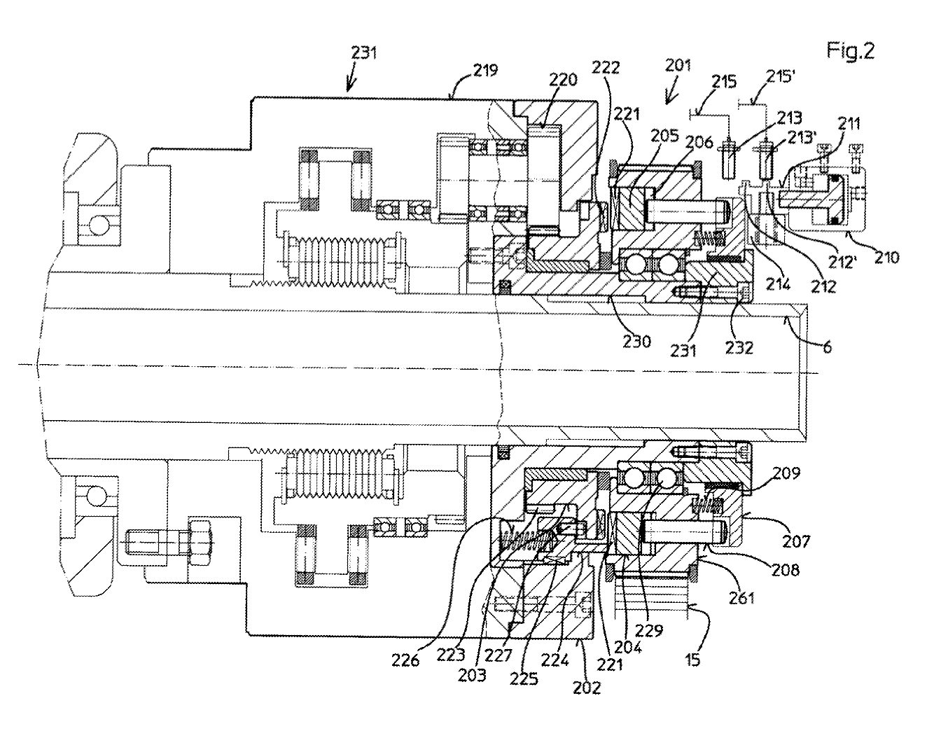

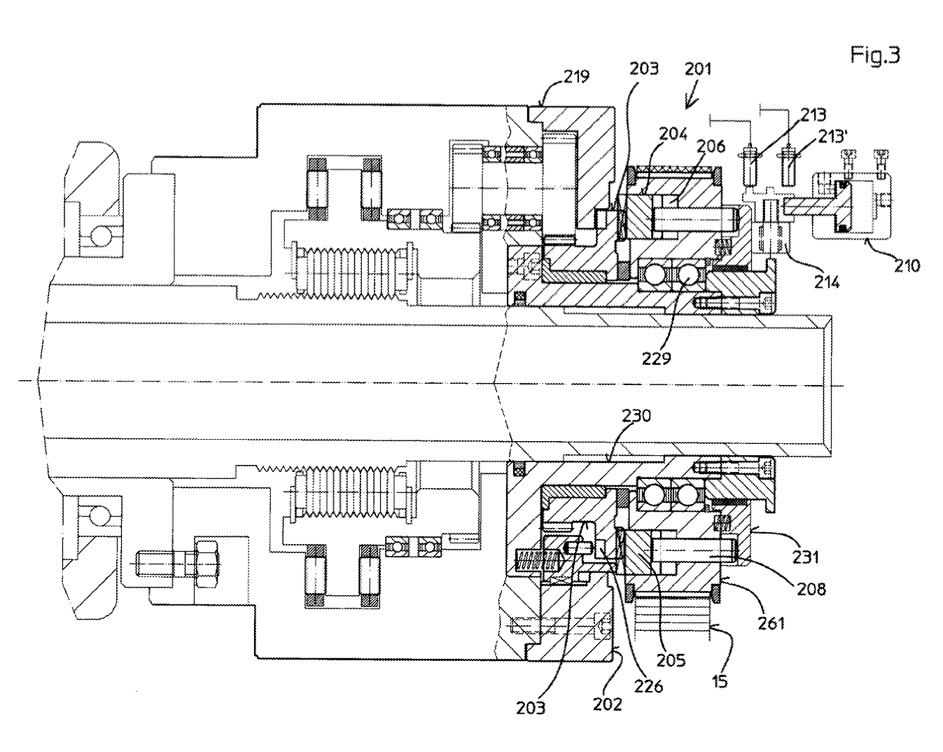

FIGS. 2 and 3 show the coupling fixture in accordance with FIG. 1 in different operating statuses and a magnified view,

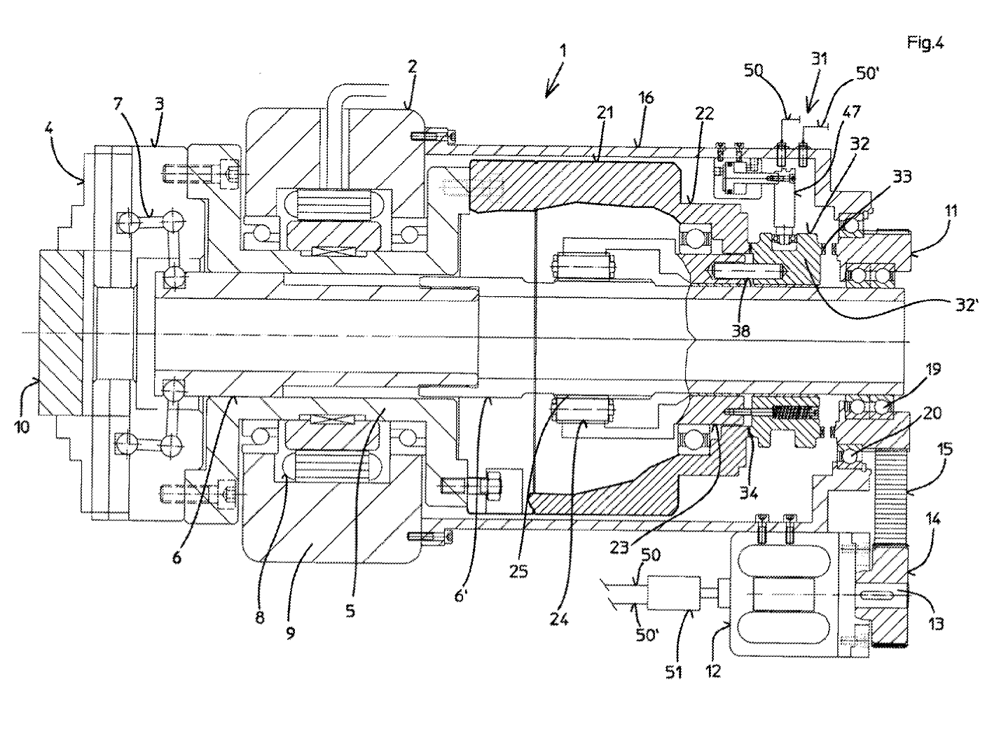

FIG. 4 shows a coupling fixture of a different embodiment, installed in the clamping device in accordance with FIG. 1,

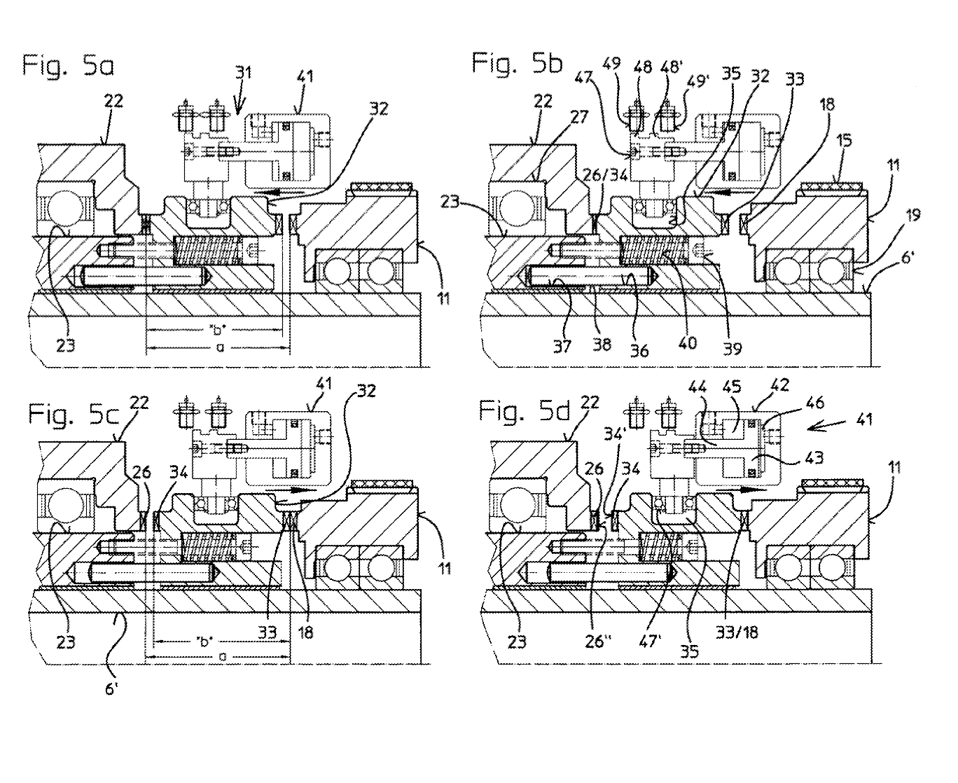

FIGS. 5a to 5d show the coupling fixture in accordance with FIG. 4 in different operating positions, in each case as a magnified view,

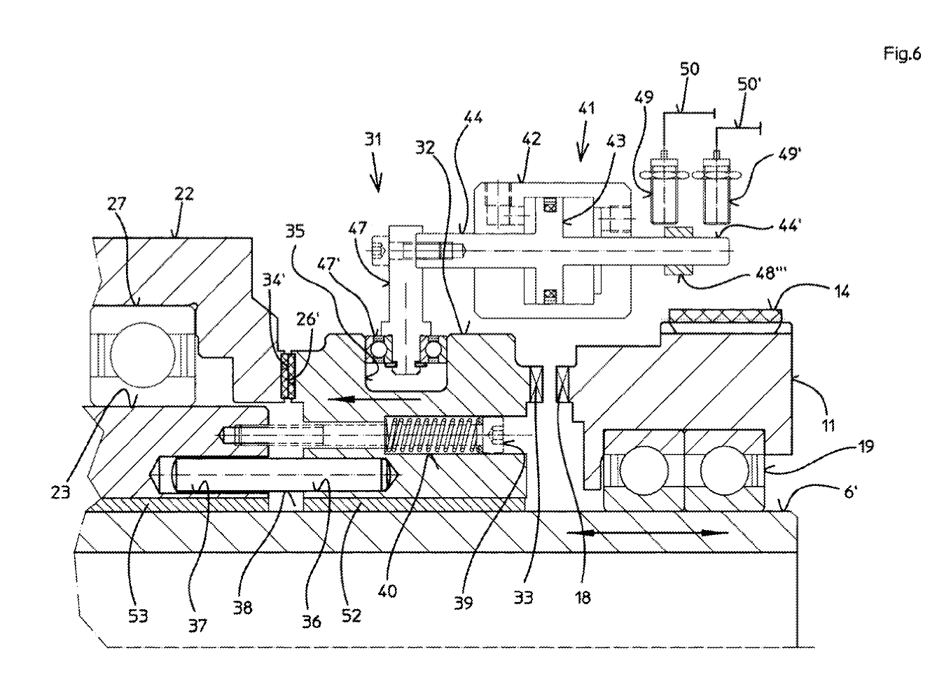

FIG. 6 shows a variant embodiment of the coupling fixture in accordance with FIG. 5b,

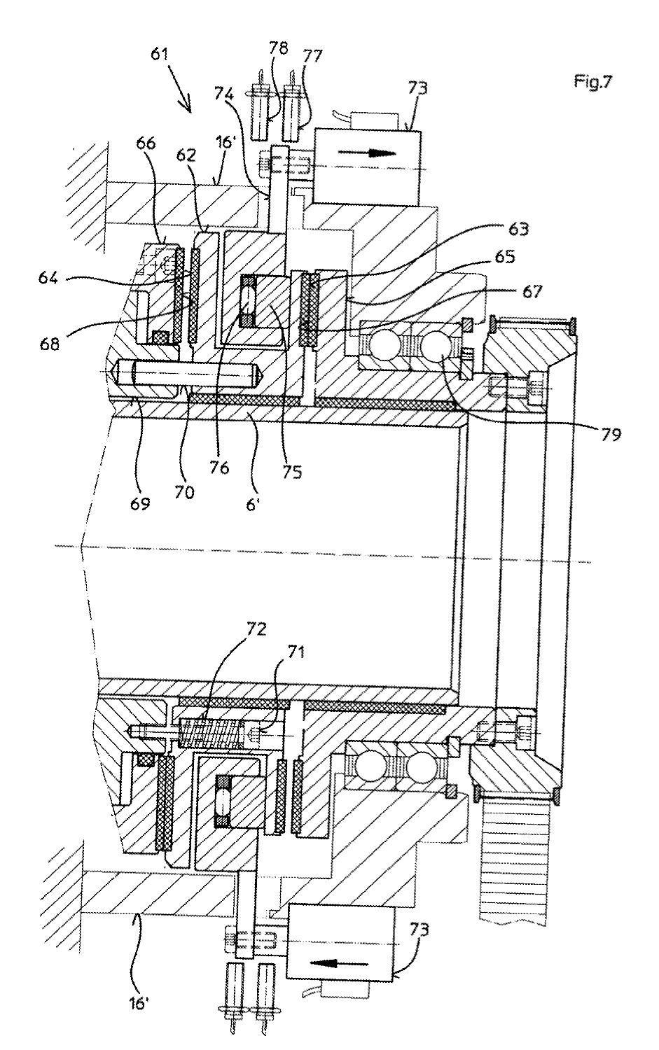

FIG. 7 shows another variant embodiment of a coupling fixture.

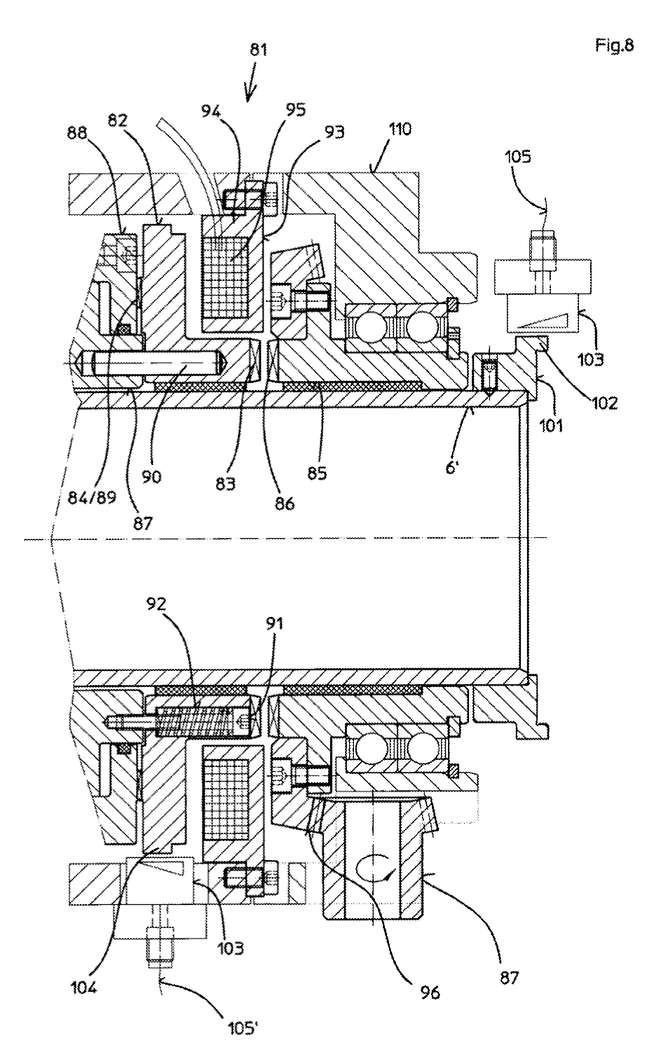

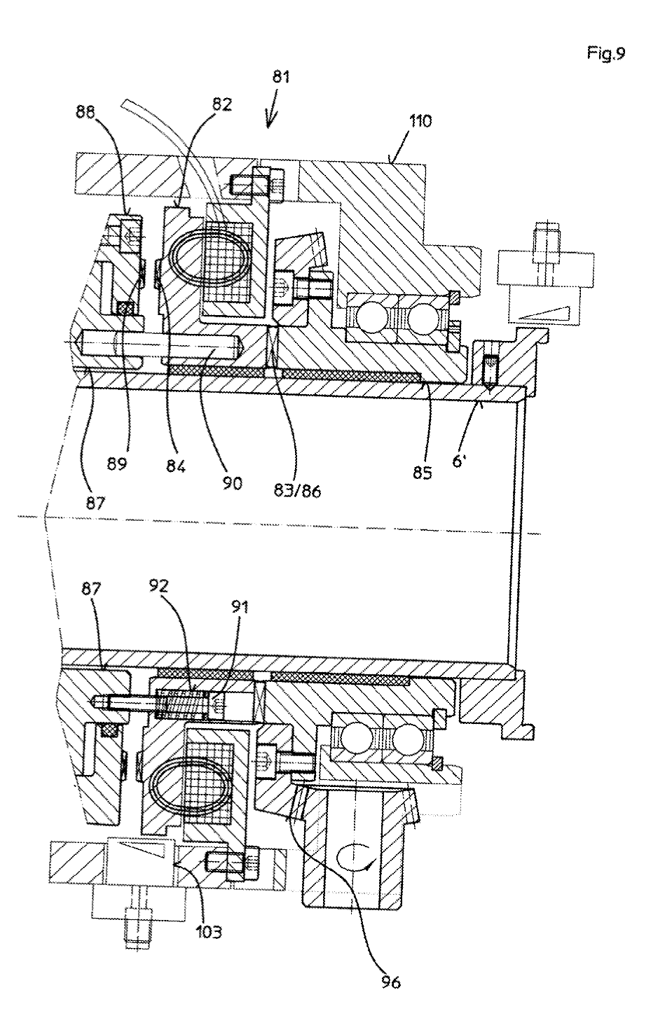

FIGS. 8 and 9 show a coupling fixture equipped with an electromagnet for adjusting the coupling element, in a different operating position,

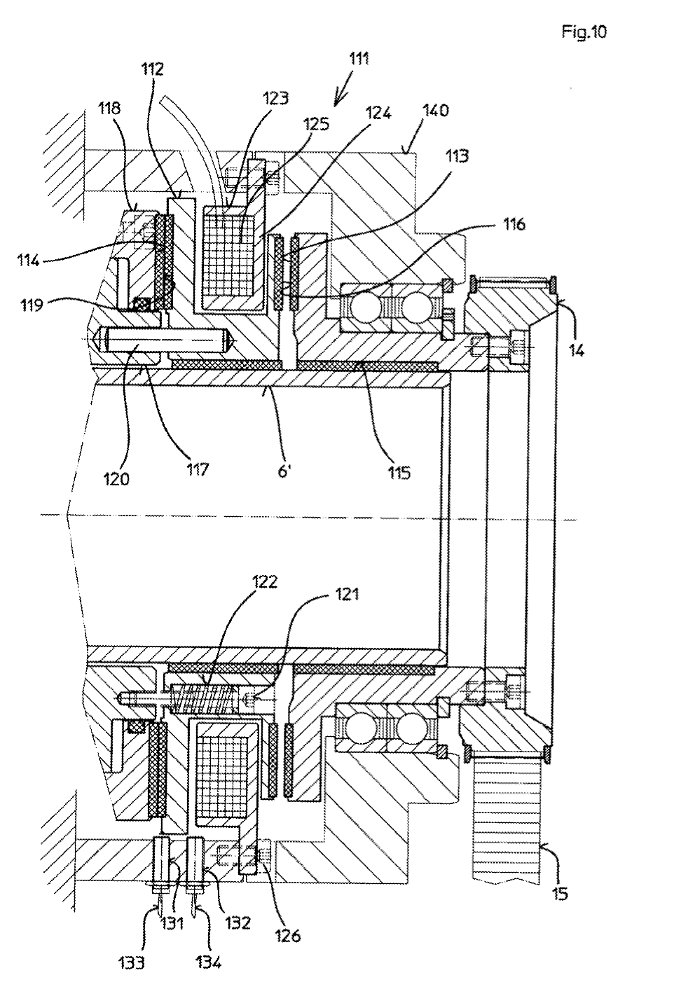

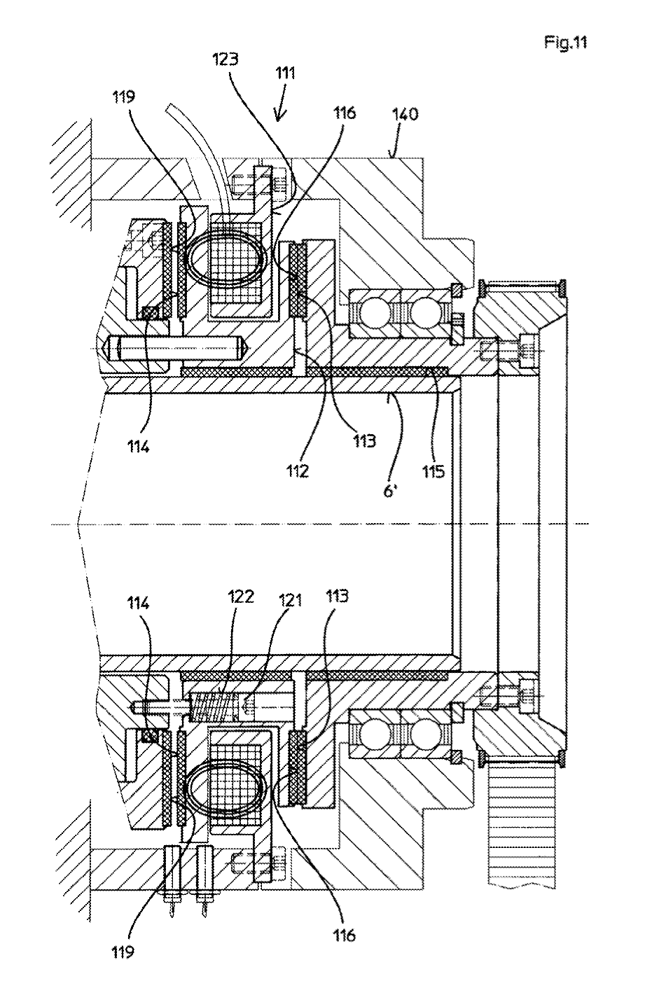

FIGS. 10 and 11 show a further variant embodiment of the coupling fixture in accordance with FIG. 8, once again in different operating positions and

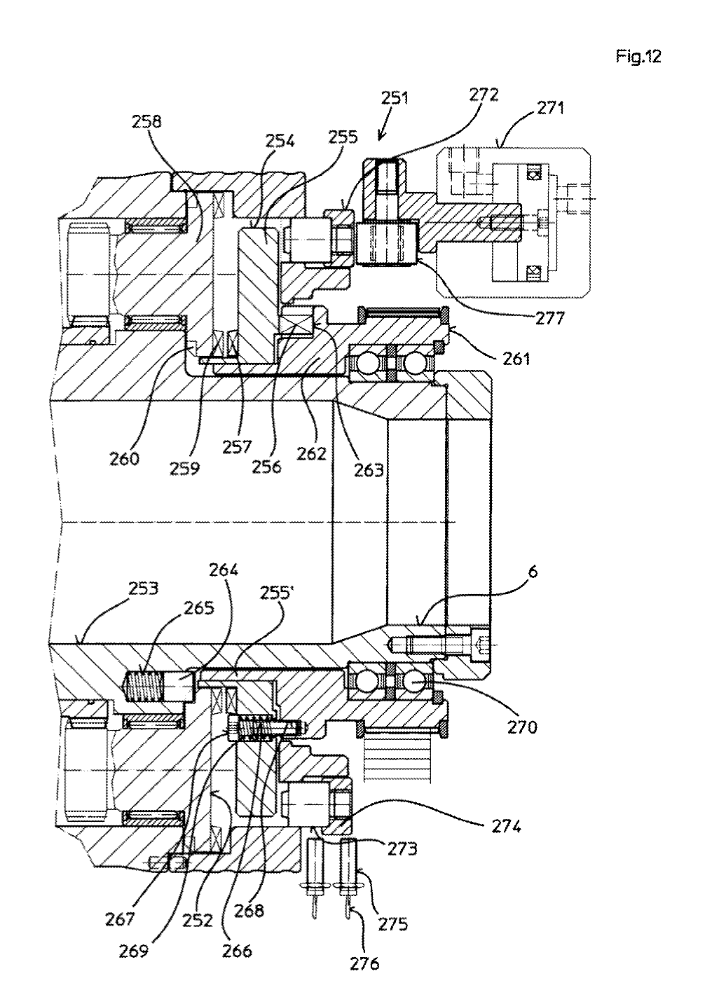

FIGS. 12 and 13 and 14 and 15 show further embodiments of the coupling fixture in accordance with FIG. 1, in each case in different operating positions and magnified views.

The clamping device illustrated in FIG. 1 and identified by 1 is used for actuating a power-operated chuck 3 arranged on a machine tool 2, by means of the radially adjustable clamping jaws 4 of which a workpiece 10 to be machined can be clamped in the chuck 3. The clamping jaws 4 of the power-operated chuck 3 in this case can be actuated via relay levers 7 by an axially mobile draw rod 6 that is in a driven connection with an electric servomotor 12 that has a changeover function by means of a drive element 261 and a movement converter 231. By means of the movement converter 231 inserted in a housing 219 firmly connected to a machine spindle 5, the rotational adjustment movements of the servomotor 12 are converted into axial feed movements of the draw rod 6.

In the servomotor 12 in this case is connected to the drive element 261 by means of a V-belt pulley 14 arranged on its rotor shaft 13 as well as a toothed or drive belt 15, in which case the drive element 261 is in a rotating mounting on the draw rod 6 by means of an anti-friction bearing 229. A carrier 218 attaches the servomotor 11 to a spindle stock 9 in which a drive motor 8 of the machine tool 2 is also installed.

In order to allow the drive element 261 2B connected with the clamping device 1 in a driving arrangement, a coupling fixture 201 is provided which has an axially adjustable coupling element 204. The coupling element 204 in this case consists of an axially movable ring 205 that is inserted in an opening 206 worked into the drive element 261, and can be actuated by a servo device 210 upon which pressurised fluid can act. An adjusting element 207, which is movably mounted on a sleeve 231 arranged on the draw rod 6, and a pin 208 upon which the adjusting element 207 acts, cause the adjusting movements triggered by the servo device 210 to be transmitted via needle rollers 214 to the adjusting element 207 which can be moved against the force of springs 209.

The clamping device 1 has two components 202 and 203 which are locked together during a working procedure and also rotate jointly. The component 202 is firmly connected to the machine spindle 5 via a bell 219 into which the movement converter 231 is also installed; the component 203, on the other hand, is supported on a sleeve 230 in a rotating arrangement, in which case the sleeve 230 is arranged on the draw rod 6 and connected to the sleeve 231 by means of screws 232. By means of a sun gear 223, the component 203 is in a driving connection with a planetary gear unit 220 which interacts with the movement converter 231.

In the working procedures to be carried out on the machine tool 2, both the components 202 and 203 are locked together and thus rotate jointly. For this purpose, tappets 224 are inserted into the component 202, each of which is in a positive locking connection with the component 202 by means of a wedge 225, and can be moved axially against the force of springs 226. In addition, the tappets 224 have the detent pins 227, and the component 203 is provided with openings 226 into which the detent pins 227 engage. An axial movement of the coupling element 204 to the left, as shown in FIG. 3, causes the ring 205 to push the tappets 224 to the left as well, as a result of which the pins 227 are separated from the component 203, meaning that both components 202 and 203 are no longer connected together.

Gearing 221 is worked onto the side surface of the ring 205 facing the component 203, and the component 203 is provided with corresponding gearing 222, both of which can be engaged with one another in order to undertake a change to the operating status of the clamping device 1. This means the drive element 261 is in a driving connection with the component 203 by means of the coupling element 204 and the gearings 221 and 222. The drive energy of the servomotor 12 is correspondingly carried through the planetary gear unit 220 and the movement converter 231 to the power-operated chuck 3, in order to trigger adjustment movements of the clamping jaws 4.

The adjusting element 207 has an intermediate element 211 allocated to it, and the intermediate element 211 is provided with the switching cams 212 and 212′ which interact with the signal transmitters 213 or 213′, as a result of which it is possible to determine the corresponding position of the coupling element 204. Signal cables 215 or 215′ allow the signals to be carried to a control device 217, as a result of which synchronisation can take place in a simple way before the gearing 221 engages in the gearing 222 of the component 203.

If the servo device 210 is reset, compression springs 209 inserted in the drive element 261 push the adjusting element 207 to the right, as a result of which the gearings 221 and 222 are separated from one another. In addition, the compression springs 226 also move the tappets 224 to the right. The pins 227 in turn engage in the openings 228, as a result of which both components 202 and 203 are locked together.

In the embodiment of the coupling fixture 31 shown in FIGS. 4 to 6, the axially adjustable coupling element 32 is configured as a disc 32′ that is in a rotationally fixed connection with a movement converter 24 by means of stud bolts 38, for example by means of a schematically illustrated planetary gear unit and a projection 23 provided on this as an inner component. The stud bolts 38 in this case are supported in holes 37 worked into the projection 23, whereas in the coupling element 32 they are firmly pressed into holes 36. The coupling element of 32 can be moved to the right against the force of compression springs 40 that act on pressure pieces 39 attached to the projection 23.

The coupling element 32, which is also mounted in a rotating arrangement on the two-part draw rod 6′ like the projection 23 using plain bearings 52 or 53, can be moved with axial control by means of a servo device 41. The servo device 41 takes the form of a piston 43 inserted in a cylinder 42 upon which a pressurised fluid can act from both sides, with an adjusting element 47 attached to its piston rod 44. As is shown in particular in FIGS. 5a to 5d and 6, the adjusting element 47 engages via an anti-friction bearing 47′ in a circumferential groove 35 worked into the coupling element 32. If pressurised fluid is supplied alternately to the pressure chambers 45 or 46 provided in the cylinder 42, the piston 43 and, with this, the adjusting element 47 acting on the coupling element 32 are moved axially, as a result of which the particularly required connection is established.

As is shown specifically in FIGS. 5a to 5d, the coupling element 32 can be moved to different switching positions, firstly in order to connect the drive element 11 to the projection 23 allocated to the movement converter 24, and secondly to connect it to the intermediate piece 22 provided on the housing 21, and thus with the machine spindle 5.

In the embodiment shown in FIG. 4 or FIGS. 5a to 5d, this is accomplished in a positively locking manner. For this purpose, gearing 18 or 26 is attached to the drive element 11 and the intermediate piece 22 on the side surfaces facing the coupling element 32, and the gearing 18 or 26 can be inserted into the gearing 33 or 34 provided on both sides of the coupling element 32. In this embodiment, the drive element 11 is in a rotating mounting by means of anti-friction bearings 19 or 20 on the draw rod 6′ and a bell 16 attached to the machine tool 2.

In FIG. 5a, the coupling element 32 is in a kind of middle position in which the gearings 33 and 34 provided on it do not engage in the gearing 18 of the drive element 11 or 26 of the intermediate piece 22. The distance a between the surfaces of the gearings 18 and 26 is namely larger than the axial width b of the coupling element 32, as a result of which premature engagement is reliably avoided.

In the operating position shown in FIG. 5b, the gearing 34 of the coupling element 32 engages in the gearing 26 worked into the intermediate piece 22 which is supported on the projection 23 by means of an anti-friction bearing 27. In this operating condition, the intermediate piece 22 is in a positively locking connection with the projection 23 by means of the coupling element 32 and the stud bolts 38. With regard to the clamping device 1, this means that it is blocked and rotates with the machine spindle 5. As a result, adjustment movements cannot be performed; instead the clamping position is maintained.

In FIG. 5c, once again, a switching position is shown prior to engagement of the gearing 33 on the coupling element 32 with the gearing 18 of the drive element 11. As shown in FIG. 5d, on the other hand, the gearing 33 of the coupling element 32 engages in the gearing 18 of the drive element 11. As a result, this is in a rotationally fixed connection with the projection 23, so consequently the rotational adjustment movements of the drive element 11 or servomotor 12 are transmitted onto the power-operated chuck 3 via the movement converter 24 that is connected to the draw rod 6′ by means of a gearing 25, and the power-operated chuck 3 is clamped or released.

As also shown specifically in FIGS. 5a to 5d and 6, the operating positions of the coupling element 32 are determined by means of switching cams 48 and 48′ or 48″ as well as signal transmitters 49 and 49′ that interact with them. Signal cables 50 and 50′ carry the signals to a control device 51 for evaluation, by means of which the servomotor 12 can be controlled, i.e. switched on or off, or its speed can be regulated.

This embodiment makes it possible to move the gearing 33 of the coupling element 32 completely into the gearing 18 of the drive element 11, even if the drive element 11 is being driven at a different speed of rotation from that of the coupling element 32.

The gearing 26 provided on the intermediate piece 22 can be provided with a friction coating 26″ on its surface at least, as shown in FIG. 5d. A friction coating of this kind can also be applied to the surface of the gearing 34 of the coupling element 32.

In accordance with the embodiment shown in FIG. 6, friction coatings 26′ or 34′ can be applied to the intermediate piece 22 and the coupling element 32, which can be configured as micro-gearing, because as shown in FIG. 3, there is no need to transmit powerful forces when the intermediate piece 23 is connected to the projection 22, in order to maintain the clamped condition of the power-operated chuck 3, for example. Rather, the engaging gearings 18 and 33 attached to the drive element 11 or coupling element 32 can be configured as trapezoidal gearing, as a result of which high forces can be applied to the power-operated chuck 3 in order to adjust it.

In the coupling fixture 61 shown in FIG. 7, friction coatings 63 and 64 are applied to both side surfaces on a coupling element 62, and these friction coatings 63 and 64 interact with the friction coatings 67 or 68 provided on the drive element 65 as well as on the component 66 to be driven, in the same way as shown in FIGS. 5a to 5d. The component 69 in a rotationally fixed connection with the coupling element 62 by means of stud bolts 70 is connected in a force-locking arrangement with the drive element 65 in the upper half of the operating position shown in FIG. 7. In this case, the drive element 65 is supported in a rotating arrangement in a bell 16′ by means of an anti-friction bearing 79.

A servo device 73 has an adjusting element 74 connected to it in an axially adjustable manner, the corresponding position of which can be established by means of locally arranged signal transmitters 77 and 78. The coupling element 62 rotates with the component 69, whereas the adjusting element 74 is supported on the servo device 73, meaning that an insert piece 75 is arranged in a rotational position in the adjusting element 74, also rotates with the coupling element 62 and is supported on the adjusting element 74 by means of an anti-friction bearing 76. Compression springs 72 supported on pressure pieces 71 inserted in the component 69 and acting on the coupling element 62, cause the coupling element 62 to be pressed against the component 69 without any influence by the servo device 73, as is shown in the lower half of the figure.

In the coupling fixture 81 or 111 shown in FIGS. 8 and 9 or 10 and 11, an electromagnet 93 or 123 attached to a bell 110 or 140 is provided in each case for axial adjustment of a coupling element 82 or 112. In the embodiment shown in FIGS. 8 and 9, a drive element 85 is connected to a servomotor that is not illustrated by means of a gear 96 attached to it, as well as a driveline 87 engaging in it; in the embodiment shown in FIGS. 10 and 11, the drive energy is supplied to the drive element 115 via a belt pulley 14 and a toothed belt 15.

The driving connection of the coupling element 82 with the drive element 85 and the component 88 is provided via gearings 83 and 84 or 86 and 89 that are attached to the coupling element 82 or the drive element 85 and the component 86. Component 87, however, connects the coupling element 82 in a rotationally fixed arrangement via stud bolts 90.

In the neutral position (FIG. 8), the coupling element 82 is pressed against the component 88 by the force of compression springs 92 that interact with pressure pieces 91, as a result of which the two components 87 and 88 are connected together in a rotationally fixed arrangement. When a magnetic coil 95 inserted in a magnet body 94 of the electromagnet 93 is reached (FIG. 9), however, the coupling element 82 is pushed in the direction of the magnet body 93 and the gearings 83 and 86 are engaged, as a result of which the component 87 is connected to the drive element 85 in a rotationally fixed arrangement.

In order to determine the particular position of the coupling element 82, the fixture 81 shown in FIGS. 8 and 9 is provided with position measuring devices 103 which interact with switching cams 102 or 104 formed onto a switching ring 101 or the coupling element 82. Signal cables 105 or 105′ carry the obtained signals to a control device in order to influence the servomotor that acts on the drive element 81. The position measuring device 103 in this case serves to ascertain the particular position of the draw rod 6, whereas the position measuring device 103 enables the position of the coupling element 82 to be determined.

The coupling fixture 111 shown in FIGS. 10 and 11 acts in the same manner as the fixture 81 according to FIG. 8. In order to connect the coupling element 112 to a drive element 115 or a component 118, friction coatings 113, 114 or 116, 118 are applied to them. In turn, stud bolts 120 are used for movable mounting of the coupling element 112, by means of which the coupling element 112 is also connected to a component 117 in a rotationally fixed arrangement. Furthermore, several compression springs 122 are inserted in the coupling element 112 and press it against the component 118 providing the magnetic coil 125 of the electromagnet 123 arranged in the magnet body 124 is not excited (FIG. 10). However, as soon as the magnetic coil 124 is supplied with electrical energy, the coupling element 112 is pressed against the force of the compression springs 122 that are supported against pressure pieces 121 inserted in the component 117 (FIG. 11), and thus against the drive element 115. As a result, it is in a friction-locking connection with the component 118.

Two signal transmitters 131 and 132 inserted in the bell 140, and which interact directly with the coupling element 112, send signals allocated to the corresponding position of the coupling element 112 via signal cables 133 or 134 to a control device on the input side of the servomotor, which are used for controlling it.

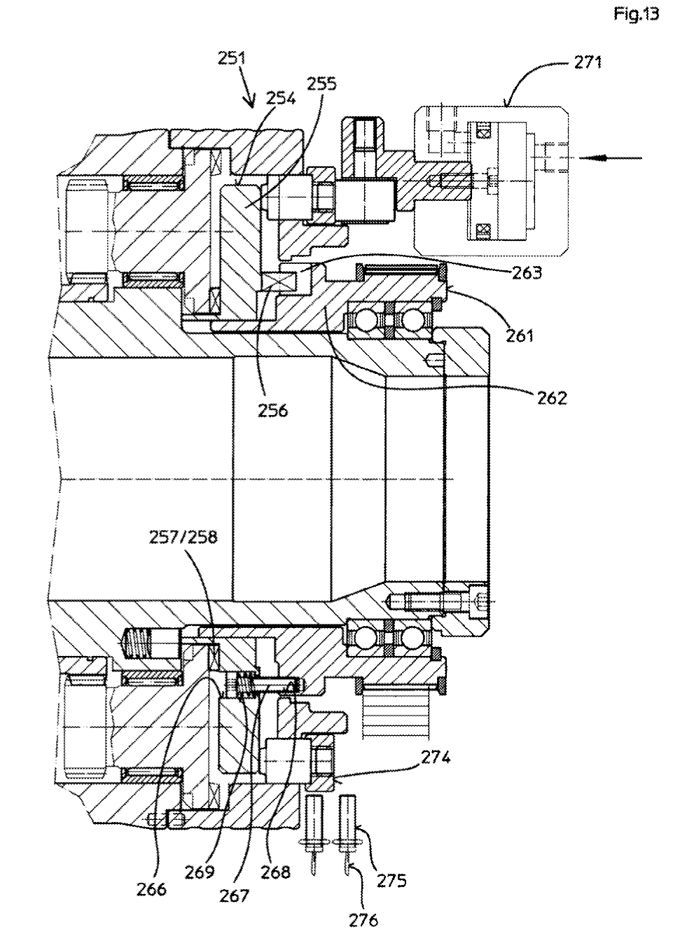

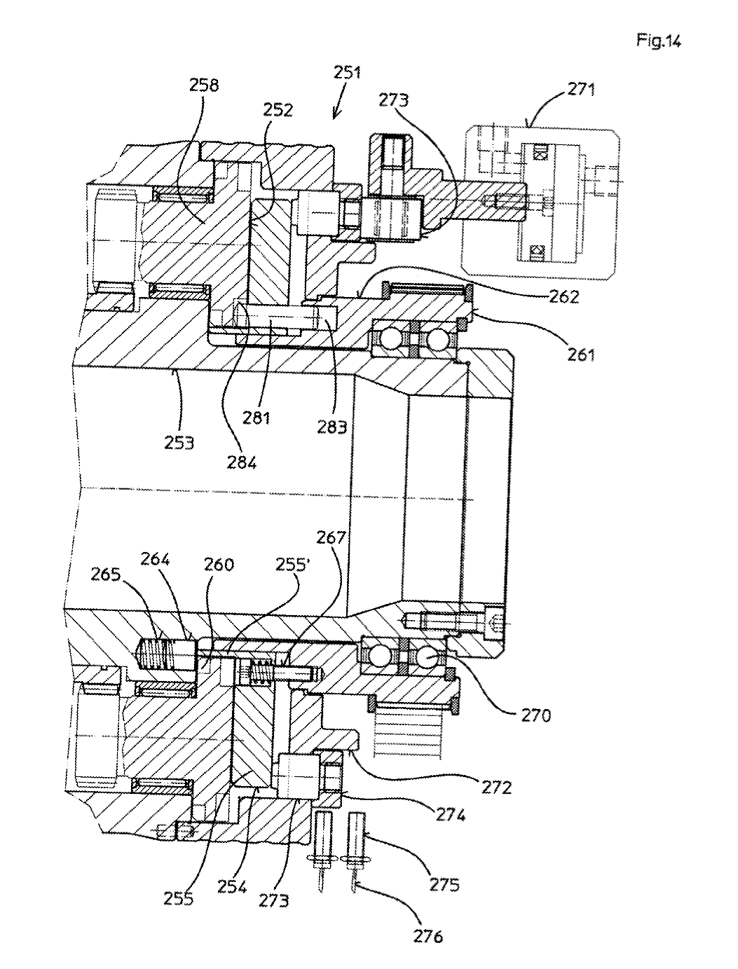

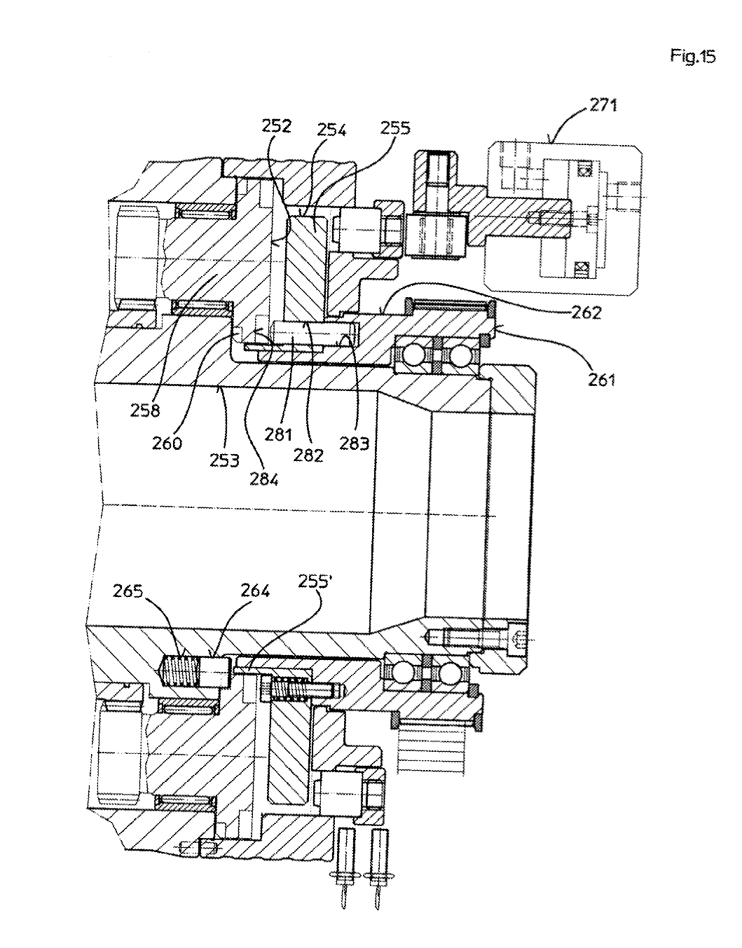

In the coupling devices shown in FIGS. 12 to 15 and indicated in each case with 251, the coupling element 254 consists of a ring disk 255 that can be actuated via needle rollers 277 by means of a servo device 271 and an adjusting element 272 allocated to the servo device 271. In this case, the coupling element 254 is continuously in a driving connection with the drive element 261, and in the case of the embodiment shown in FIGS. 12 and 13, by means of interlocking gearings 256 and 253 worked on to the disc 255 and a projection 262 of the drive element 261, whereas in FIGS. 14 and 15, this is done by means of pins 281 that are firmly inserted into the holes 282 in the disc 255 and engage in holes 283 provided in the drive element 261. For this purpose, the drive element 261 is equipped with the axially protruding projection 262 which carries the gearing 263 or the holes 283.

The two components 252 and 253 that are allocated to the clamping device 1 in the same way as in the embodiment in FIG. 1 can be locked together by means of the detent pins 264 that are inserted in the component 253 and can be moved against the force of springs 265. The detent pins 264 that engage in openings 284 worked into planetary gears 258 can be actuated by means of a projection 255′ protruding from the disk 255, as can be seen in FIGS. 13 and 15.

In the embodiment shown in FIGS. 13 and 14, the coupling element 254 can be connected to the planetary gears 258 by means of gearing 275 formed on the disk 255 and on the planetary gears 258, in a positively locking arrangement. In the embodiment shown in FIGS. 14 and 15, this is accomplished by means of the pins 281 that can be inserted into the openings 284 worked into the planetary gears 258 e.g. in the manner of a headstock gearing. In this way, the drive element 261 that is in a rotating mounting on the draw rod 6 by means of a bearing 270 can be connected via the coupling element 254 to transmit energies into the power-operated chuck 3.

The discs 255 of both coupling fixtures 251 are connected in a rotationally fixed arrangement with the drive element 281 by means of pin bars 267 that are inserted into threaded holes 268 worked into the drive element 281, and can be moved against the force of springs 269 in openings 266 provided in the disc 255. If the servo device 271 is returned to the operating position shown in FIGS. 12 and 14, the connection of the disc 255 with the planetary gears 258 is automatically released and the two components 252 and 253 are locked together by means of the pins 264 that can engage in the openings 260.

Switching cams 274 are formed onto the adjusting element 272 that acts on the disc 255 via the tappet 273, and these switching cams 274 interact with signal transmitters 275 in order to determine the corresponding position of the coupling element 254, in which case the signals from the signal transmitters to Und and 75 can in turn be sent to a control device by means of signal cables 276. The rotation speed of the drive element and 61 or the servomotor allocated to it can thus be controlled according to the ascertained operating status.

1. A fixture for reciprocal connection between two components rotating in opposite directions to one another and disposed on a drive element by an axially adjustable coupling element for connecting the drive element of an electrical clamping device therewith, by means of which rotational adjustment movements of the drive element are adapted to be converted into axial adjustment movements,
wherein
the coupling element is rotationally fixed to the drive element, or one of the two components, wherein two components are adapted to be locked together directly, or by means of the coupling element, and the locking of the two components is releasable by movement of the coupling element axially.

2. The fixture in accordance with claim 1,
wherein
the coupling element comprises an axially movable ring disposed in the drive element and which is comprised a disc, or by a plurality of pins adapted to be operated jointly, and are adapted to be inserted in the drive element, wherein the disc or pins are adapted to be connected to one of the two components in a rotationally fixed arrangement.

3. The fixture in accordance with claim 1,
wherein
the coupling element inserted in the drive element is adapted to be actuated by a transmission element formed by one or more of the pins in an axially movable arrangement.

4. The fixture in accordance with claim 1,
wherein
the two components are locked together in the neutral position of the coupling element by detent pin means inserted in a first of the components and is moveable axially against the force of springs, and engageable with openings provided in a second of the components.

5. The fixture in accordance with claim 4,
wherein
the coupling element, or one of the components, is provided with a projection disposed generally at the height of the detent pins, by means of which the detent pins are actuatable directly, or by means of intermediate elements, through axial movement of the coupling element, thereby releasing the lock.

6. The fixture in accordance with claim 1,
wherein
the coupling element is provided with gearing or friction surfaces on at least one side surface which interacts with corresponding gearing or friction surfaces provided on the drive element, and/or on the component which is rotatably supported.

7. The fixture in accordance with claim 6,
wherein
in order for the drive element to be connected to the coupling element under load, a distance between surfaces of gearing provided on the drive element and on the component in a rotating arrangement, is larger than an axial width of the coupling element.

8. The fixture in accordance with claim 7,
wherein
the coupling element and the drive element are adapted to be driven at equal or different speeds during engagement and disengagement.

9. The fixture in accordance with claim 6,
wherein
one or both of the gearings on the surfaces of the components in a rotating arrangement and on the coupling element are provided with a wear-resistant friction covering, a coating, or knurling.

10. The fixture in accordance with claim 6,
wherein
the interacting gearing provided on the coupling element and the drive element comprises trapezoidal gearing, and the gearing provided on the coupling element and the component in a rotating arrangement comprises micro-gearing.

11. The fixture in accordance with claim 6,
wherein
the interacting gearings of the coupling element and the drive element are provided with a greater tooth depth than the reciprocal gearings provided on the component in a rotating arrangement and on the coupling element.

12. The fixture in accordance with claim 1,
wherein
the coupling element comprises a sliding sleeve and is connected in a rotationally fixed arrangement with the component in a rotating arrangement by means of one or more stud bolts, with the coupling element connected to the component in a movable axial arrangement.

13. The fixture in accordance with claim 1,
wherein
the coupling element is connected in a rotationally fixed arrangement with the drive element by gearing in continuous engagement, or one or more stud bolts inserted in the drive element.

14. The fixture in accordance with claim 1,
wherein
a servo device is provided for axial adjustment of the coupling element, the servo device comprising an adjustable piston in a cylinder adapted to be acted on by pressurised fluid on at least one side and which acts on the coupling element, and an electrically operated servo device.

15. The fixture in accordance with claim 14,
wherein
a force-locking connection is provided between the drive element and the coupling element, and an adjustable element of the servo device acting on the coupling element is provided with an insert supported in a rotating mounting.

16. The fixture in accordance with claim 12,
wherein
a locationally fixed electromagnet provides for axial adjustment of the coupling element, by means of which the coupling element is adjustable in a controlled manner against a return spring force.

17. The fixture in accordance with claim 1,
wherein
one or more springs are disposed in the coupling element and are effective in the direction of the component connected to the coupling element in a rotationally fixed arrangement.

18. The fixture in accordance with claim 17,
wherein
each of the springs is arranged on a pressure piece connected to one of the components in a rotating arrangement, and on the free end of which the springs act.

19. The fixture in accordance with claim 1,
wherein
in order for an axial position of the coupling element to be established, signal transmitter means are provided which operate influenced by the coupling element by means of switching cams, directly or via intermediate elements, with signals from the transmitters sent to a control device, or to the drive element, and/or a drive motor.
